(19) United States
(12) Patent Application Publication
(10) Pub. No.: US 2010/0074575 A1
(43) Pub. Date: Mar. 25, 2010

(54) OPTICAL MODULE AND METHOD FOR MANUFACTURING THE SAME

(76) Inventor: Hidenobu HAMADA, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/559,785

(22) Filed: Sep. 15, 2009

(30) Foreign Application Priority Data
Sep. 19, 2008 (JP) 2008-240473

(51) Int. Cl. G02B 6/12

(52) U.S. Cl. 385/14

(57) ABSTRACT

An optical waveguide includes three cores formed within a single cladding, and each of the cores embed therein a light source and a light-receiving section, whose respective optical axes are aligned to each other. The light-receiving section includes a tapered reflective side surface, a light blocking section, and a light-receiving body. The tapered reflective side surface guides, among lights that propagate through the cores, only a light having an incidence angle within a range whose upper limit of is an angle θ_{0C} decided based on NA of the optical waveguide, to an effective light-receiving portion. The tapered reflective side surface has a spread angle facing toward a direction of the light source, and is installed in a periphery of the effective light-receiving portion. An aperture diameter of the tapered reflective side surface is designed to be equal to or less than a width (or diameter) of the cores.

### BACKGROUND OF THE INVENTION

1. Field of the Invention

The present invention relates to: an optical module that has an optical waveguide configuration which includes a core and a cladding, which are suitable for optical interconnection, optical communication, and the like; and a manufacturing method for the optical module.

2. Description of the Background Art

In recent years, associated with improvements in infrastructures for high-speed information and communication, digital devices that conduct calculation, accumulation, and display of large volume data have been rapidly developed. In order to handle such large volume data, increase in signal transmission speed and densification of a signal wiring have been demanded for use in a relatively short-distance information transmission that occurs between boards and between chips on a board and the like within an electronic device. However, there are limits to the achievable level in the increase of the transmission speed and in the densification of the wiring, since a wiring that utilizes an electrical signal has problems such as signal delay due to a time constant of the wiring, noise generation, and the like.

In order to solve such problems, an optical interconnection that utilizes an optical signal is gathering attention. This optical interconnection is an optical transmission path that is utilized to conduct a transmission of an optical signal, and is typically an optical waveguide. For example, when conducting a short distance transmission of a signal between a first chip and a second chip, which are mounted on a board, an optical interconnection between the first chip and the second chip is formed by means of an optical waveguide. An electrical signal outputted from the first chip is modulated into a laser light, propagates through the optical waveguide, is demodulated back into an electrical signal, and is outputted into the second chip.

Generally, a plurality of electrical signal wirings are parallelly connected to a chip and the like. Therefore, if the plurality of electric wirings are to be substituted with an optical interconnection, a parallel optical interconnection, which has channels that are equal in number with the number of the electric wirings (number of cores, number of the wavelengths, and the like), is predominantly used. One typical structure of the parallel optical interconnection is an optical waveguide 110 that has a cover cladding structure in which a plurality of cores 111 are covered by a single cladding 112 (refer FIG. 18).

In order to avoid a usage of a bulky lens for the optical interconnection in which miniaturization and integration are demanded, an application of a butt joint for coupling the optical waveguide and the laser light or a light receiving element is becoming the mainstream technology instead of using a lens. As a result, dealing with a cross talk between the channels has become an important issue for the parallel optical interconnection.

Here, a mechanism, which is relevant to the cross talk, of an excitation due to an incidence of light to the core in the optical waveguide in which a light propagates from a light source toward a z direction, is described.

Dispersion characteristics of the core, the cladding, and air can be represented by formula [1] described below. Here, k_{y} is a wave number of the optical waveguide in y direction, and k_{z} is a propagation constant of the optical waveguide.

Two modes exist in each domain of, the core, the cladding, and the air; and these modes are, a fast-wave mode (k_{z}²>0, k_{y}²>0) in which a light diffuses in an arbitrary direction as a result of a propagation constant in free space being larger than a propagation constant k_{z} in the optical waveguide, and a slow-wave mode (k_{z}²>0, k_{y}²<0) in which a light diffuses and propagates only in z direction as a result of the propagation constant in free space being smaller than a propagation constant k_{z} in the optical waveguide. In reality, another mode, which is an evanescent-wave mode (k_{z}²<0, k_{y}²>0), also exists; however, this mode is not directly related to the present invention thus description of this mode is omitted.

If propagation constants in the core, in the cladding, and in the air which is free space, are respectively defined as k_{core}, k_{clad}, and kₐᵢᵣ, since refractive indexes become small in the order of the core, the cladding, and the air, a relationship of k_{core}>k_{clad}>kₐᵢᵣ is satisfied.

$$\{ \begin{matrix}{k}_{z}^{2} + {k}_{y}^{2} = {k}_{core}^{2} & ( Core ) \\ {k}_{z}^{2} + {k}_{y}^{2} = {k}_{clad}^{2} & ( Cladding ) \\ {k}_{z}^{2} + {k}_{y}^{2} = {k}_{air}^{2} & ( Air )\end{matrix} \qquad [ 1 ]$$

In a case where a point light source such as a laser is used, even when the light source and the core in the optical waveguide are coupled having optical axes of the light source and the core aligned perfectly, a propagation constant k_{z} in the optical waveguide can have a value ranging from 0 to k_{core}, since a light from the light source diffuses in all directions. Therefore, from relationships between dispersion surfaces of the core, the cladding, and the air, shown in FIG. 19, an excitation light as a consequence of an incidence of light from the light source to the core at light source wavelength ω₀ can be classified into: [A] a case of k_{core}>k_{z}>k_{clad} where an incidence angle portion, which is smaller than a total reflection angle at a core-cladding boundary surface, contributes; [B] a case of k_{clad}>k_{z}>kₐᵢᵣ where an incidence angle portion, which is equal to or larger than the total reflection angle described above and which is equal to or smaller than a total reflection angle at a cladding-air boundary surface, contributes; and [C] a case of kₐᵢᵣ>k_{z} where an incidence angle portion, which is equal to or larger than a total reflection angle at an air boundary surface and which is close to a right angle, contributes.

Excited in [A] the case of k_{core}>k_{z}>k_{clad} are: a same-core propagating light (solid line A1) which is generated at a fast-wave dispersion surface on the core and which has a light intensity with a strong eigenmode; and a light leaking out into the cladding (dashed line A2), which is generated at a slow-wave dispersion surface on the cladding and which leaks from the core to a cladding side and which propagates along the core-cladding boundary surface and which is extremely faint.

Excited in [B] the case of k_{clad}>k_{z}>kₐᵢᵣ are: a cladding propagating light (dashed line B1) which is generated at a fast-wave dispersion surface on the cladding and which has a light intensity with a weak eigenmode; an all-cores propagating light (solid line B2) which corresponds to a refracted light of the cladding propagating light directed toward cores and which is generated at a fast-wave dispersion surface on the core and which is extremely faint; and a light leaking out into the air (dotted line B3), which is generated at a slow-wave dispersion surface of the air and which leaks from the cladding to an air side and which propagates along the cladding-air boundary surface and which is extremely faint.

Excited in [C] the case of k_{z}<kₐᵢᵣ is a diffusion light (dotted line C1) generated at a fast-wave dispersion surface of the air; however, this light diffuses into the air and does not contribute to propagation.

Based on the dispersion characteristics described above, FIG. 20 shows a propagating light profile when a light enters a core Ch1 that is included in the cover cladding structure described in FIG. 18. In FIG. 20, various spots are gradually represented, where a bright spot is represented in white and a dark spot is represented in black.

As indicated by a two dimension FDTD (Finite Difference Time Domain) simulation result shown in (a) of FIG. 20, elements that cannot be ignored intensity-wise are: the same-core propagating light A1 which has a strong light intensity and which is generated in the core Ch1; the cladding propagating light B1 which has a weak light intensity and which is generated throughout the whole cover cladding; the all-cores propagating light B2 which has a faint light intensity and which is generated in all cores including a core Ch2 and a core Ch3; and a diffusion light C3 that is generated in the air domain.

As can be seen from an experiment result shown in (b) of FIG. 20, with regard to the propagating light that has a propagation constant of k_{clad}>k_{z}>kₐᵢᵣ, the all-cores propagating light B2 generated in the all cores has a smaller amount of light than the cladding propagating light B1 generated in the cover cladding. Therefore, among the excitation lights that resulted from the incident light to the core Ch1, as a light that causes a cross talk within the optical waveguide from the Ch1 to the Ch2 and to the Ch3, the cladding propagating light B1 has the largest intensity while the all-cores propagating light B2 has a small influence. The reason for why the amount of light of the all-cores propagating light B2, which is only a refracted light of the cladding propagating light B1, is smaller than the amount of light of the cladding propagating light B1, is possibly because a canceling effect due to an interference is generated since the all-cores propagating light B2 is more harmonic (large wave number k_{y}) than the cladding propagating light B1. However, caution is necessary when, as shown in FIG. 21, a light-receiving section is separated away from the optical waveguide too much, since the cladding propagating light enters the light-receiving section directly from the cover cladding, leading to an increased influence of a cross talk between the optical waveguide and the light-receiving section due to a diffusion of light.

In the two dimension FDTD simulation described above: the core in each channel have a width of 3 μm, and a refractive index of 1.6, while an interval between two adjacent cores is 7 μm; the cover cladding has a width of 21 μm, and a refractive index of 1.4; and a light source wavelength is configured at approximately 850 nm. In addition, in the experiment: the core in each channel have a 35 μm □, and a refractive index of approximately 1.53, while an interval between two adjacent cores is 250 μm; the cover cladding has a width of 10 μm, a film thickness of 100 μm, and a refractive index of approximately 1.50; and a light source wavelength is configured at approximately 850 nm.

As a measure for reducing a cross talk between channels, there is a technology described in Japanese Laid-Open Patent Publication No. S60-254690 (patent document 1). In patent document 1, an integration of the optical waveguide and an electric circuit board, and a coupling of the optical waveguide to the light source and the light receiving element, are simultaneously attained by embedding the light source and the light receiving element, which are on the electric circuit board, into the optical waveguide. Furthermore, a reduction of the cross talk between the channels is achieved by: in a case where a single core exists, conducting a wavelength multiplex optical transmission by utilizing different wavelengths for each channel; and in a case where a plurality of cores exist, conducting optical transmissions by implementing section boundary walls so as to provide independent optical waveguides for each of the channels.

As a measure for reducing the cross talk between channels, there is a technology described in Japanese Laid-Open Patent Publication No. H11-352344 (patent document 2). In patent document 2, in order to reduce the cross talk between the channels, in an optical waveguide that includes a plurality of parallel cores, a V-shaped groove, which is groove with air, is provided at a cladding portion at an interval between two adjacent cores.

With the technology of patent document 1 described above, although the section boundary wall is implemented in the case where the plurality of cores exist, the cross talk is not completely eliminated, thus, a problem remains where the light receiving element receives optical signals that have various incidence angles.

Furthermore, in patent document 2 described above, the cross talk cannot be completely eliminated since the V-shaped groove is provided only to one part of the cladding, thus, a problem remains where the light receiving element receives optical signals that have various incidence angles.

### SUMMARY OF THE INVENTION

Therefore, an objective of the present invention is to provide: an optical module that has a structure which allows a reduction of a cross talk between channels in a parallel optical interconnection, by limiting an incidence angle of a light that is received by a light receiving element; and a manufacturing method for the optical module.

The present invention is directed toward an optical module that has a cover cladding structure. In order to achieve the objective described above, the optical module of the present invention includes: a plurality of light sources; a plurality of light-receiving sections; and an optical waveguide that includes, a plurality of cores which individually align an optical axis of each of the plurality of light sources and an optical axis of each of the plurality of light-receiving sections and which conduct optical coupling of the light source and the light-receiving section, and a cladding that covers the plurality of cores. Each of the plurality of light-receiving sections includes: a light-receiving body that receives a light; and an incident light guiding section that guides, among incident lights that propagate through the cores, only a light having an incidence angle within a range whose upper limit is an angle decided based on NA of the optical waveguide, to the light-receiving body. The optical module may further include: a board on which the optical waveguide is mounted and which is curvable toward a direction of a normal line to the optical axis; and a fixation base that fixes the board.

The incident light guiding section includes a tapered reflective side surface that has: a light-reflecting function; a spread angle whose center line matches the optical axis and which faces toward a direction from where an incident light arrives; and a shape where an aperture diameter at a tip of the tapered reflective side surface is equal to or less than a minimum width of the core. The spread angle and the aperture diameter of the incident light guiding section are derived based on a refractive index of the core in the optical waveguide and on a refractive index of the cladding in the optical waveguide. Alternatively, the incident light guiding section includes an angle selection minor which is formed of a transparent material that has a refractive index equal to or smaller than a value of a square root of a difference between a square of the refractive index of the core in the optical waveguide and a square of the refractive index of the cladding in the optical waveguide, and which has a plane, perpendicular to the optical axis facing toward a direction from where an incident light arrives, and which selects a light that passes through based on the incidence angle. In this case, it is necessary for at least a tip portion of the tapered reflective side surface and the plane of the angle selection mirror, which is perpendicular to the optical axis, to be either embedded inside the core, or in contact with an end surface of the core.

A typical light-receiving body includes: a photoelectric conversion section that converts a received light into a charge; and an electrode pair that collects the charge generated by the photoelectric conversion section. The photoelectric conversion section may be a P-N junction type semiconductor; or may include a transparent organic host material that has a conductive property, and an organic pigment which absorbs a wavelength dispersed within the organic host material and which then generates a charge. In the latter case, the organic host material is preferable a same material as the core.

According to the present invention described above, even in a cover cladding structure, only a light from the same channel is received whereas a light from another channel is not received. Thus, a cross talk between channels in a parallel optical interconnection can be reduced.

These and other objectives, features, aspects and advantages of the present invention will become more apparent from the following detailed description of the present invention when taken in conjunction with the accompanying drawings.

### BRIEF DESCRIPTION OF THE DRAWINGS

FIG. 1 is a diagrammatic perspective view of a structural example of optical modules 1 to 3 according to first to third embodiments of the present invention;

FIG. 2A shows an x-y cross section of the optical module 1 at point a in FIG. 1;

FIG. 2B shows a y-z cross section of the optical module 1 at point b in FIG. 1;

FIG. 2C shows an x-z cross section of the optical module 1 at point c in FIG. 1;

FIG. 3 is a figure for describing, a structural example of a light-receiving section 14, and a positional relationship of the light-receiving section 14 and a core 11, in the optical module 1;

FIG. 4 is a figure for describing a reflection of a light at a tapered reflective side surface 141;

FIG. 5 is a figure for describing a dispersion characteristic of an optical waveguide 10;

FIG. 6 is a figure for describing a reason why a cross talk between channels can be reduced;

FIG. 7 is a figure for describing another positional relationship between the light-receiving section 14 and the core 11;

FIG. 8A shows an x-y cross section of the optical module 2 at point a in FIG. 1;

FIG. 8B shows a y-z cross section of the optical module 2 at point b in FIG. 1;

FIG. 8 C shows an x-z cross section of the optical module 2 at point c in FIG. 1;

FIG. 9 is a figure for describing, a structural example of the light-receiving section 14, and a positional relationship of the light-receiving section 14 and the core 11, in the optical module 2;

FIG. 10 is a figure for describing a dispersion characteristic of the optical waveguide 10 in the optical module 1;

FIG. 11 is a figure for describing a reason why the cross talk between the channels can be reduced;

FIG. 12 is a figure for describing another positional relationship between the light-receiving section 14 and the core 11;

FIG. 13 shows a y-z cross section of the optical module 3 at point b in FIG. 1;

FIG. 14 shows another structural example of the light-receiving section 14;

FIG. 15 is a figure for describing one example of a manufacturing process of an optical module of the present invention;

FIG. 16 is a figure for describing another example of the manufacturing process of the optical module of the present invention;

FIG. 17 is a figure showing a general outline of a processing method that applies dicing or mold casting, which are used in the manufacturing processes in FIG. 15 and FIG. 16;

FIG. 18 is a figure for describing a structure of a general optical waveguide 110 that has a cover cladding structure;

FIG. 19 is a figure for describing a dispersion characteristic of an optical waveguide 110;

FIG. 20 is a figure showing a general outline of a propagating light profile with the optical waveguide 110; and

FIG. 21 is a figure for describing a cross talk that is generated in the optical waveguide 110.

### DESCRIPTION OF THE PREFERRED EMBODIMENTS

In the following, embodiments of the present invention will be described with reference to drawings.

### First Embodiment

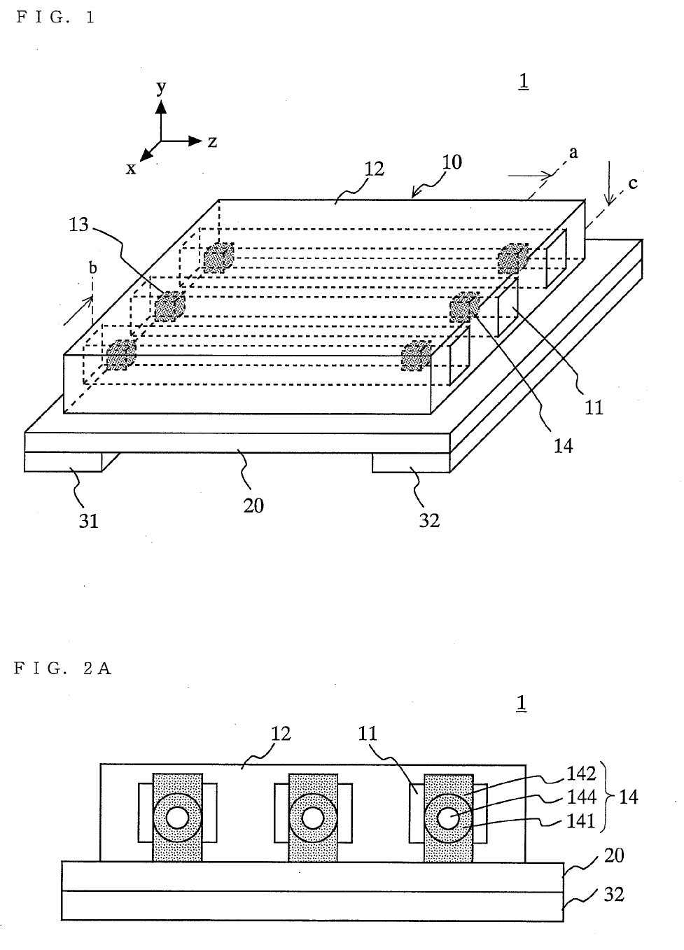

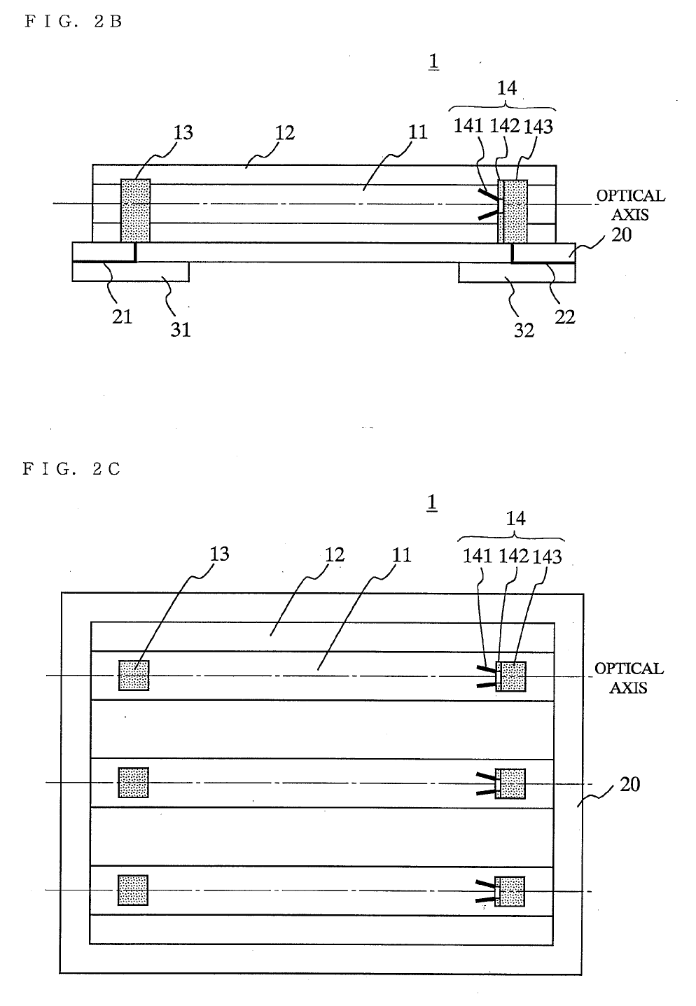

FIG. 1, and FIG. 2A to FIG. 2C are figures for describing a structure of an optical module 1 according to a first embodiment of the present invention. FIG. 1 is a diagrammatic perspective view of the optical module 1. FIG. 2A shows an x-y cross section of the optical module 1 at point a in FIG. 1; FIG. 2B shows a y-z cross section of the optical module 1 at point b in FIG. 1; and FIG. 2C shows an x-z cross section of the optical module 1 at point c in FIG. 1.

The optical module 1 according to the first embodiment has a structure in which an optical waveguide 10 is mounted on a board 20 that is fixed on fixation bases 31 and 32. In the optical waveguide 10, three cores 11 are formed within a single cladding 12, and a light source 13 and a light-receiving section 14 are embedded within each of the cores 11 and are facing each other.

Optical axes of the light source 13 and the light-receiving section 14 are aligned. The board 20 is preferable a flexible board that can be curved toward a direction of a normal line of a plane that includes this optical axis. The number of cores 11 formed within the single cladding 12 does not necessarily have to be three. In addition, electrical signal wirings 21 and 22 are respectively connected to the light source 13 and the light-receiving section 14; however, detailed diagrammatic representation or description of the electrical signal wirings 21 and 22 are omitted since they are is not relevant to the principal objective of the present invention.

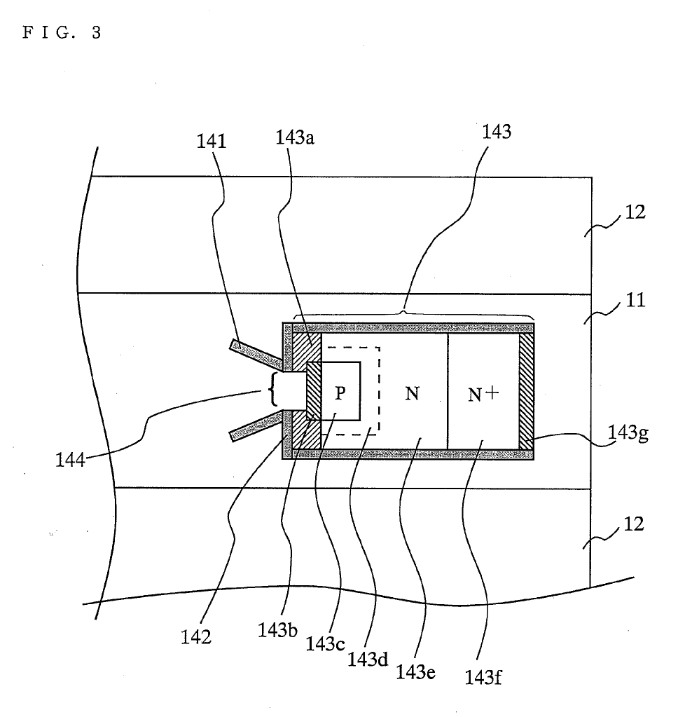

FIG. 3 is a figure for describing features of the present invention, which is, a structure of the light-receiving section 14, and a positional relationship of the light-receiving section 14 and a core 11.

The light-receiving section 14 includes: a tapered reflective side surface 141; a light blocking section 142; and a light-receiving body 143. The allocation of the light blocking section 142 determines an effective light-receiving portion 144 that actually receives a light in the light-receiving body 143. The tapered reflective side surface 141 has a light-reflecting function, and is an incident light guiding section that guides, among incident lights that propagate through the core 11, only a light having an incidence angle within a range whose upper limit is an angle θ_{0C} decided based on NA (Numerical Aperture) of the optical waveguide 10, to the light-receiving body 143. The tapered reflective side surface 141, has a spread angle whose center line matches the optical axis and which faces toward a direction from where an incident light arrives (light source 13 direction), and is installed in a periphery of the effective light-receiving portion 144. An aperture diameter at a tip of the tapered reflective side surface 141 is designed to be equal to or less than a minimum width (or minimum diameter) of the core 11.

The light-receiving body 143 is a P-N junction type semiconductor that typically includes: an anode electrode 143b formed from a conductive transparent electrode; a P layer 143c which is a light-receiving portion; a depletion layer 143d; an N layer 143e, an N+ layer 143f, and a cathode electrode 143g. When the light blocking section 142 is formed from a metallic material, an insulation film 143a is disposed between the light blocking section 142 and the anode electrode 143b. Furthermore, the anode electrode 143b preferably has an area that is larger than the effective light-receiving portion 144.

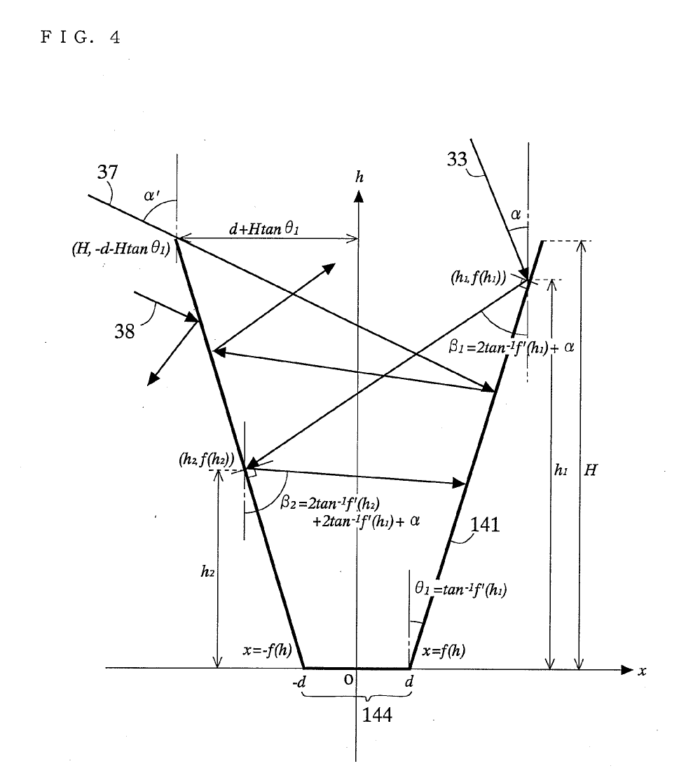

Next, a mechanism for how a cross talk between channels can be reduced in a cover cladding structure by applying a light-receiving section 14 structure that includes the tapered reflective side surface 141 described above, will be described by additionally referring to FIG. 4. FIG. 4 is a figure for describing a dispersion characteristic of the tapered reflective side surface 141.

In an example in FIG. 4, in an x-h plane (in this case, h direction is identical to—z direction), an angle θ_{0C} is derived by using a two dimension model for multi-reflection; when an original point o of the x-h plane is defined as a center of the effective light-receiving portion 144, and when a width of the effective light-receiving portion 144 is defined as 2d, and when a tapered shape of the tapered reflective side surface 141 is represented by functions of x=f(h)=h×tan θ₁+d, and x=−f(h)=−h×tan θ₁−d.

The next formula [2] represents: an asymptotic equation of a reflection position (hₘ, f(hₘ)) at the m-th time of reflection of a light 33 that entered having an incidence angle α against the optical axis (h axis); and a reflection angle βₘ of the light (angle formed between—h axis). From formula [2], it can be understood that the reflection angle becomes larger in association with an increase in the number of times of reflection.

$$\{ \begin{matrix}\frac{f ( {h}_{m} ) - f ( {h}_{m - 1} )}{{h}_{m} - {h}_{m - 1}} = tan [ 2 {\sum }_{i = 1}^{m - 1} {tan}^{- 1} {f}^{′} ( {h}_{i} ) + α ] \\ {β}_{m} = 2 {\sum }_{i = 1}^{m} {tan}^{- 1} {f}^{′} ( {h}_{i} ) + α\end{matrix} \qquad [ 2 ]$$

The light 33 is reflected outside the tapered reflective side surface 141 and is not received by the effective light-receiving portion 144, if the reflection position of the light 33 does not reach the effective light-receiving portion 144 (hₘ>0) and if the reflection angle βₘ becomes 90 degrees or more, at the m-th time of reflection. Thus, the next formula [3] describes a condition when the effective light-receiving portion 144 does not receive any lights.

$$\{ \begin{matrix}{h}_{m} > 0 \\ {β}_{m} \geq \frac{π}{2}\end{matrix} \qquad [ 3 ]$$

In addition, a condition, when the maximum incidence angle αₘₐₓ of a light that is received by the effective light-receiving portion 144 becomes equal to or less than angle θ_{0C}, can be obtained as the next formula [4] from the second formula in formula [3].

$${θ}_{0 c} \geq {α}_{max} = \frac{π}{2} - 2 {\sum }_{i = 1}^{m} {tan}^{- 1} {f}^{′} ( {h}_{i} ) \qquad [ 4 ]$$

Here, when a shape function f(h) that represents the tapered shape of the tapered reflective side surface 141 is linear: f′(hᵢ)=tan θ₁ (θ₁: a spread angle of the tapered reflective side surface) as shown in FIG. 3, the formula [4] above becomes the next formula [5]. However, sin θ_{0C}=(n_{core}²−n_{clad}²)^{1/2}.

$${θ}_{1} \geq \frac{1}{2 m} [ \frac{π}{2} - {sin}^{- 1} ( \sqrt{{n}_{core}^{2} - {n}_{clad}^{2}} ) ] \qquad [ 5 ]$$

On the other hand, hₘ can be inductively obtained from simultaneous equations with m number of variables, which can be obtained from the first formula in formula [3]; and for example, when m=2, simultaneous equations with two variables that can derive h₂ will be the next formula [6].

$$\{ \begin{matrix}\frac{f ( {h}_{1} ) - f ( {h}_{0} )}{{h}_{1} - {h}_{0}} = - tan α \\ \frac{f ( {h}_{2} ) - f ( {h}_{1} )}{{h}_{2} - {h}_{1}} = tan ( 2 {θ}_{1} + α )\end{matrix} \qquad [ 6 ]$$

An incident light will be received without being reflected when the incidence angle is α≦θ₁ regardless of a length H of the tapered shape; whereas, an incident light will not be received when α≧αₘₐₓ. Therefore, within a range of the incidence angle θ_{0C}≧αₘₐₓ≧α>θ₁ where multi-reflection at the tapered reflective side surface 141 becomes an issue, an incidence position of a threshold incident light 37 (H, −d−H tan θ₁), which is a boundary between a blocked light 38 that cannot enter the tapered reflective side surface 141 and an incident light that can enter the tapered reflective side surface 141, can be described as (h₀, f(h₀)).

Accordingly, a light receiving position h₂ on the tapered shape at the time of the second (m=2) multi-reflection can be represented by the next formula [7].

$${h}_{2} = \frac{\frac{H ( tan α - tan {θ}_{1} ) - 2 d}{tan α + tan {θ}_{1}} [ tan ( 2 {θ}_{1} + α ) + tan {θ}_{1} ] + 2 d}{tan ( 2 {θ}_{1} + α ) - tan {θ}_{1}} \qquad [ 7 ]$$

In addition, h₂>0 can be derived from the first formula in formula [3], and the length H of the tapered reflective side surface 141 can be represented by next formula [8].

$$H > \frac{2 d}{tan α - tan {θ}_{1}} [ 1 - \frac{tan α + tan {θ}_{1}}{tan ( 2 {θ}_{1} + α ) + tan {θ}_{1}} ] \\ ( ∵ \frac{π}{2} > 2 {θ}_{1} + α > {θ}_{1} ) \qquad [ 8 ]$$

Finally, from θ_{0C}≧αₘₐₓ≧α>θ₁, the next formula [9] can be obtained.

$$H > \frac{2 d}{tan {θ}_{0 c} - tan {θ}_{1}} ( 1 - \frac{tan {θ}_{0 c} + tan {θ}_{1}}{tan 3 {θ}_{1} + tan {θ}_{1}} ) \qquad [ 9 ]$$

When calculations are actually conducted by utilizing these numerical formulae, if n_{core}=1.6, n_{clad}=1.5, and d=15 μm, values such as θ_{0C}=33.8 deg, θ₁≧14.0 deg, H>14.3 μm can be obtained.

Although a case where the number of multi-reflection is two is described in the example above, since the spread angle θ₁ becomes smaller as the value of m becomes larger, the shape may be optimized while taking into consideration of the difficulty of a process and the like. Furthermore, other than the linear shape, the shape function f(h) that represents the tapered shape of the tapered reflective side surface 141 may have a curved-shape such as a trumpet shape and a bowl shape. In this case, a light receiving condition can be calculated as done similarly in the case with the linear shape, by substituting the function f(h).

If the tapered reflective side surface 141 is formed in accordance with the condition described above, the cross talk between the channels can be reduced as described next.

First, the same-core propagating light A1 that propagates through the core 11 in the same channel has an incidence angle α that is equal to or less than the angle θ_{0C} decided based on NA. Therefore, among the same-core propagating light A1 that enters the tapered reflective side surface 141, a light that satisfies α≦αₘₐₓ (≦θ_{0C}) is received by the light-receiving body 143, whereas a light that satisfies αₘₐₓ<α<θ_{0C} is reflected outside the tapered reflective side surface 141 and is not received by the light-receiving body 143.

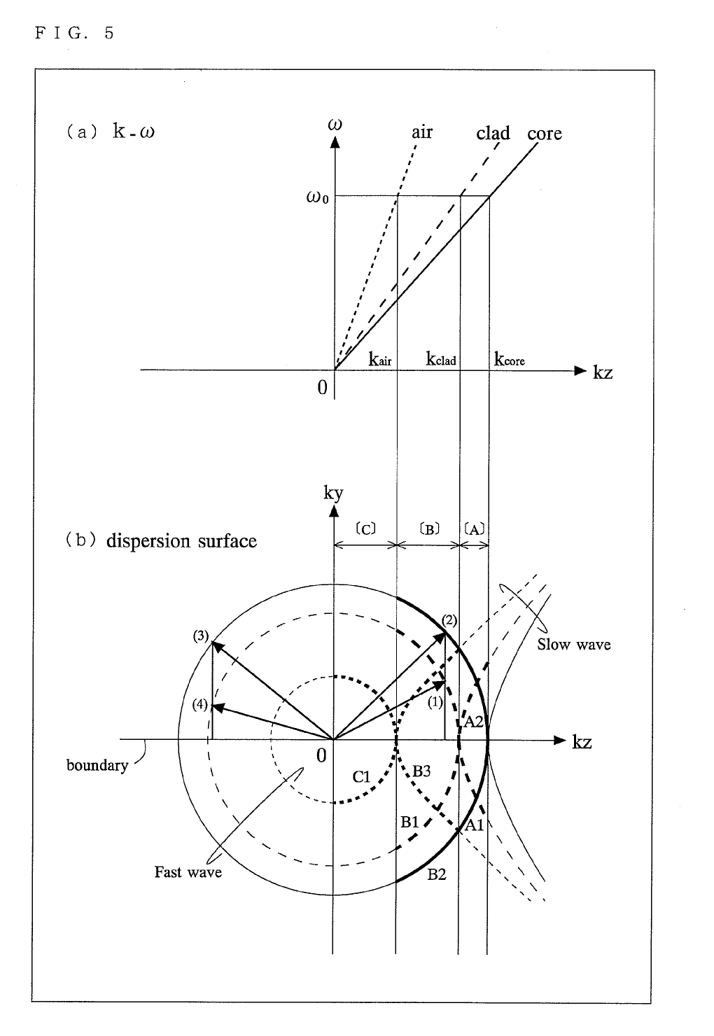

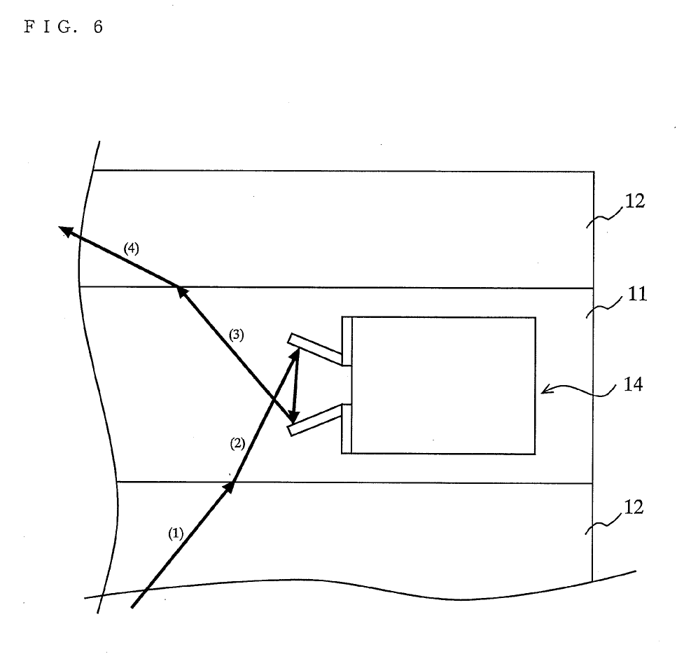

Next, the all-cores propagating light B2 (e.g. plane wave (2) in FIG. 5 and FIG. 6), which is generated when the cladding propagating light B1 (e.g. plane wave (1) in FIG. 5 and FIG. 6) is refracted upon entering, can be effectively prevented from being received, by providing the tapered reflective side surface 141 so as to restrict a light acceptance angle, in addition to embedding the effective light-receiving portion 144 of the light-receiving section 14 within the core 11 where an influence of the cross talk is small. Since the incidence angle α of the all-cores propagating light B2 is equal to or more than θ_{0C} decided based on NA, the light that enters the tapered reflective side surface 141 is always equal to or more than the maximum light acceptance angle (α≧θ_{0C}≧αₘₐₓ); thus, the all-cores propagating light B2 is reflected outside the tapered reflective side surface 141 (e.g. plane wave (3) in FIG. 5 and FIG. 6), and becomes the cladding propagating light B1 (e.g. (4) in FIG. 5 and FIG. 6) and is not received by the light-receiving body 143.

As described above, in the optical module 1 according to the first embodiment of the present invention, the tapered reflective side surface 141 that satisfies formula [5] and formula [9] described above is formed on the light-receiving section 14, and the effective light-receiving portion 144 of the light-receiving section 14 is embedded in the core 11. With this, even in a cover cladding structure, a parallel optical interconnection, which does not allow the cross talk, and which allows only a light from the same channel to be received while not allowing a light from another channel to be received, can be attained.

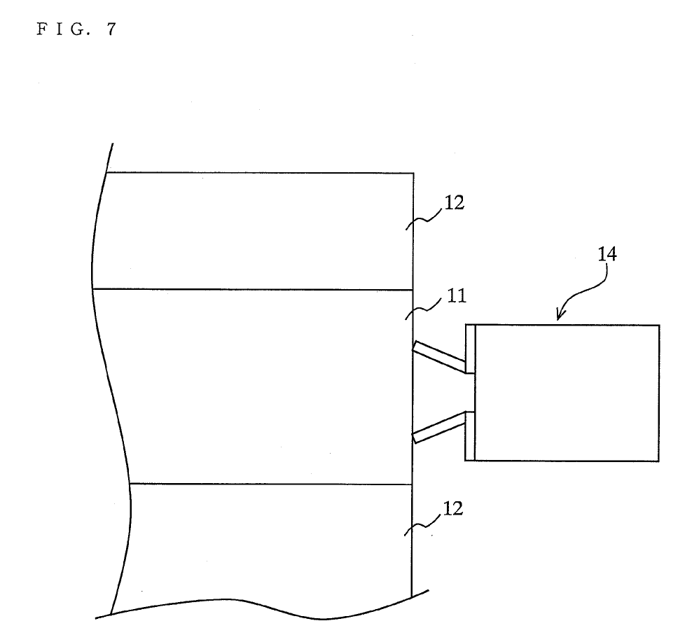

In the first embodiment of the present invention, although described above is a structure in which the tapered reflective side surface 141 of the light-receiving section 14 is embedded within the core 11, it is not necessary to embed the whole of the tapered reflective side surface 141 within core 11 as long as the diameter of the tapered reflective side surface 141 is equal to or less than the width of the core 11. All that is needed is, to have at least the tip portion of the tapered reflective side surface 141 to be embedded inside the core 11, or to be in contact with an end surface of the core 11 (refer FIG. 7).

### Second Embodiment

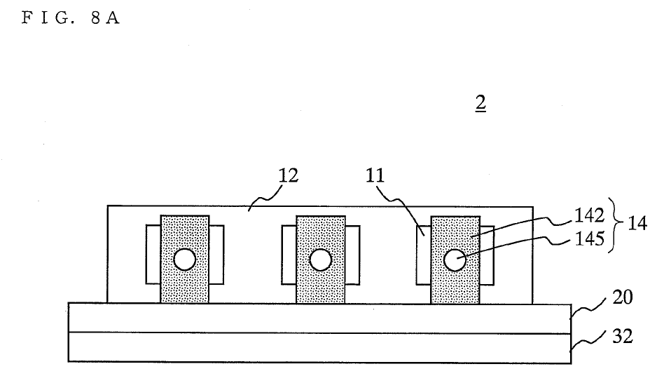

A diagrammatic perspective view of an optical module 2 according to a second embodiment of the present invention is identical to the view in FIG. 1. FIG. 8A shows an x-y cross section of the optical module 2 at point a in FIG. 1; FIG. 8B shows a y-z cross section of the optical module 2 at point b in FIG. 1; and FIG. 8C shows an x-z cross section of optical module 1 at point c in FIG. 1.

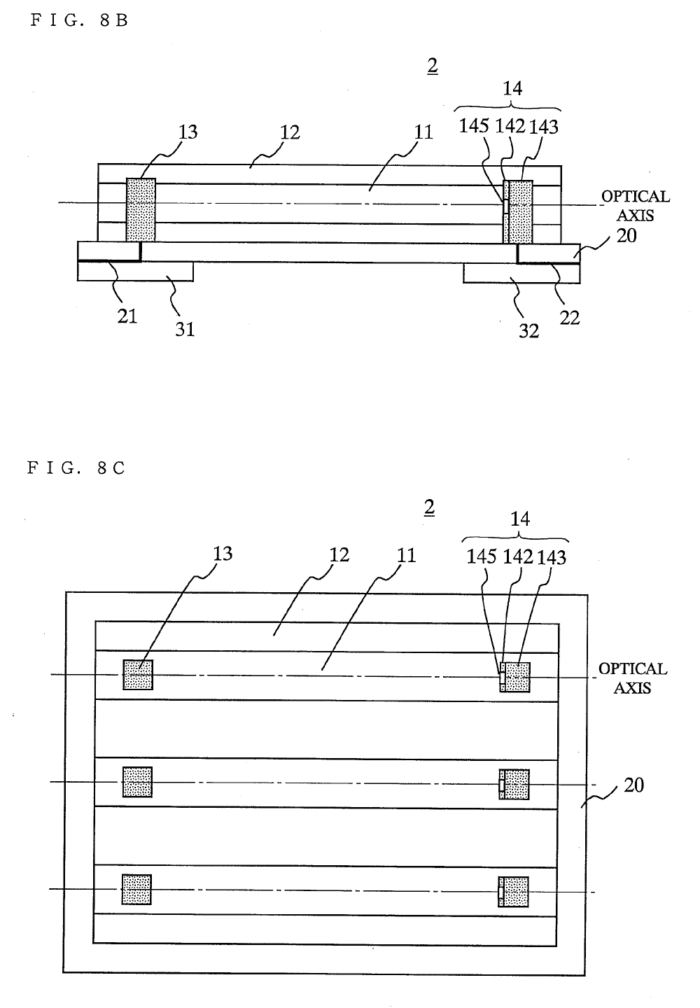

FIG. 9 is a figure for describing features of the present invention, which is, a structure of the light-receiving section 14, and a positional relationship of the light-receiving section 14 and the core 11.

The light-receiving section 14 includes: the light blocking section 142; the light-receiving body 143; and an angle selection mirror 145. The allocation of the light blocking section 142 determines the effective light-receiving portion 144 that actually receives a light in the light-receiving body 143. The angle selection mirror 145 is an incident light guiding section that guides, among incident lights that propagate through the core 11, only a light having an incidence angle within a range whose upper limit is an angle θ_{0C} decided based on NA of the optical waveguide 10, to the light-receiving body 143. The angle selection mirror 145 is formed of a transparent material that has a refractive index equal to or smaller than a value of a square root of a difference between a square of the refractive index of the core 11 and a square of the refractive index of the cladding 12; and is fitted on the effective light-receiving portion 144 so as to have a plane of the angle selection mirror 145 perpendicular to the optical axis to be on a side of the incident light.

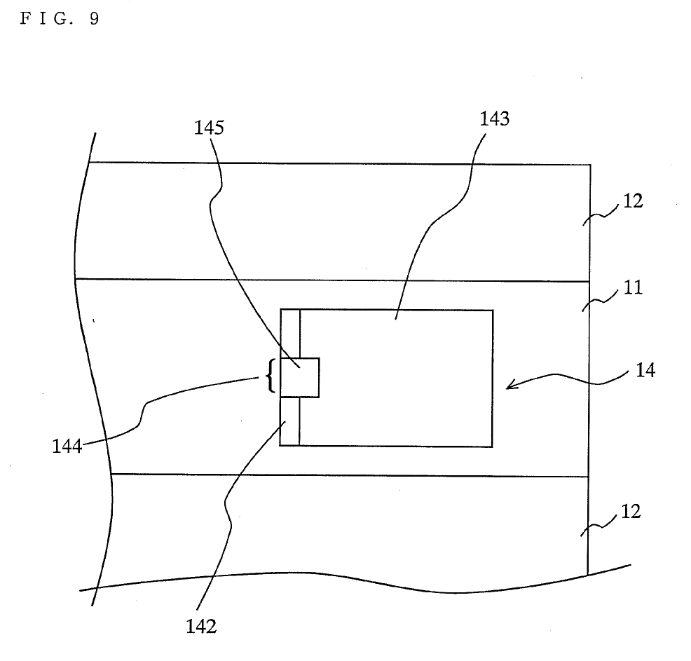

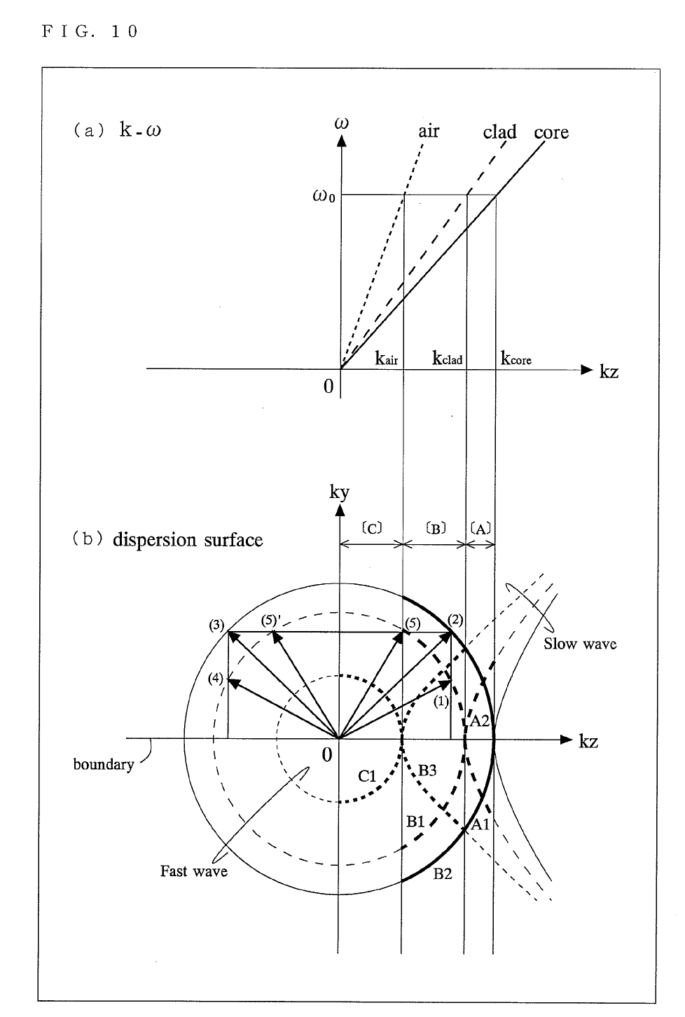

Next, a mechanism for how the cross talk between the channels can be reduced in a cover cladding structure by applying a light-receiving section 14 structure that includes the angle selection mirror 145 described above, will be described by additionally referring to FIG. 10 and FIG. 11.

First, regarding the same-core propagating light A1 that propagates through the core 11 in the same channel, k_{clad}>|k_{y}| is satisfied at the angle selection mirror 145 which has a refractive index of n₁ (<(n_{core}²−n_{clad}²)^{1/2}), and at a boundary surface that is perpendicular to the optical axis of the core 11 in k_{y} direction. Therefore, among the same-core propagating light A1 that enters the angle selection mirror 145: a light that satisfies |k_{y}|<k₁ passes through the angle selection mirror 145 and is received by the light-receiving body 143; a light that satisfies |k_{y}|=k₁ is not received by the light-receiving body 143, since the light is a surface wave that propagates along the boundary surface; and a light that satisfies k_{clad}>|k_{y}|>k₁ is not received by the light-receiving body 143, since the light is totally reflected.

Since the angle θ_{0C}, which is defined as sin θ_{0C}=(n_{core}²−n_{clad}²)^{1/2} and which is decided based on NA of the optical waveguide 10, becomes equal to or more than an upper limit of light acceptance angle γₘₐₓ, of the effective light-receiving portion 144 as shown by next formula [10]; the only light that can pass through the effective light-receiving portion 144 is the same-core propagating light A1 that satisfies |k_{y}|<k₁.

$$sin ( \frac{π}{2} - {γ}_{max} ) = \sqrt{{n}_{core}^{2} - {n}_{1}^{2}} \geq {n}_{clad} = sin ( \frac{π}{2} - {θ}_{0 c} ) \qquad [ 10 ]$$

Next, the all-cores propagating light B2 (e.g. plane wave (2) in FIG. 10 and FIG. 11), which is generated when the cladding propagating light B1 (e.g. plane wave (1) in FIG. 10 and FIG. 11) is refracted upon entering, can be effectively prevented from being received, by providing the angle selection mirror 145 so as to perform a light acceptance angle restriction, in addition to embedding the angle selection mirror 145 of the light-receiving section 14 within the core 11 where an influence of the cross talk is small. Regarding the all-cores propagating light B2, |k_{y}|>(k_{core}²−k_{clad}²)^{1/2} is satisfied, at the angle selection mirror 145 which has the refractive index n₁ (<(n_{core}²−n_{clad}²)^{1/2}), and at a boundary surface that is perpendicular to the optical axis of the core 11 in k_{y} direction. Therefore, the all-cores propagating light B2 is coupled only, with a plane wave (3) that is reflected on the surface of the angle selection mirror 145, and with surface waves (5) and (5)′ that propagate along the surface of the angle selection mirror 145; thus, is not received by the light-receiving body 143. In other words, the all-cores propagating light B2 that has an incidence angle equal to or larger than θ_{0C} decided based on NA, satisfies θ_{0C}>γₘₐₓ, thus, cannot pass through the angle selection mirror 145.

As described above, in the optical module 2 according to the second embodiment of the present invention, in addition to having the angle selection mirror 145 of the light-receiving section 14 embedded within core 11; the angle selection mirror 145, which has a refractive index equal to or smaller than a value of a square root of a difference between a square of the refractive index of the core 11 and a square of the refractive index of the cladding 12, is formed in the light-receiving section 14. With this, even in a cover cladding structure, a parallel optical interconnection, which does not allow the cross talk, and which allows only a light from the same channel to be received while not allowing a light from another channel to be received, can be attained.

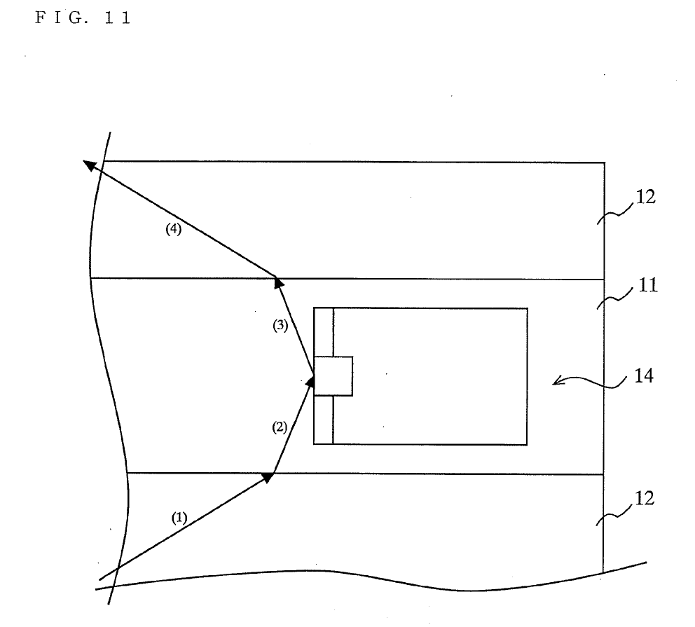

In the second embodiment described above, although described is a structure in which the angle selection mirror 145 of the light-receiving section 14 is embedded within the core 11, it is not necessary to embed the whole of the angle selection mirror 145 within the core 11 as long as the angle selection mirror 145 and the core 11 are optically coupled. All that is needed is, to have at least the plane of the angle selection mirror 145 perpendicular to the optical axis to be embedded inside the core 11, or to be in contact with the end surface of the core 11 (refer FIG. 12).

### Third Embodiment

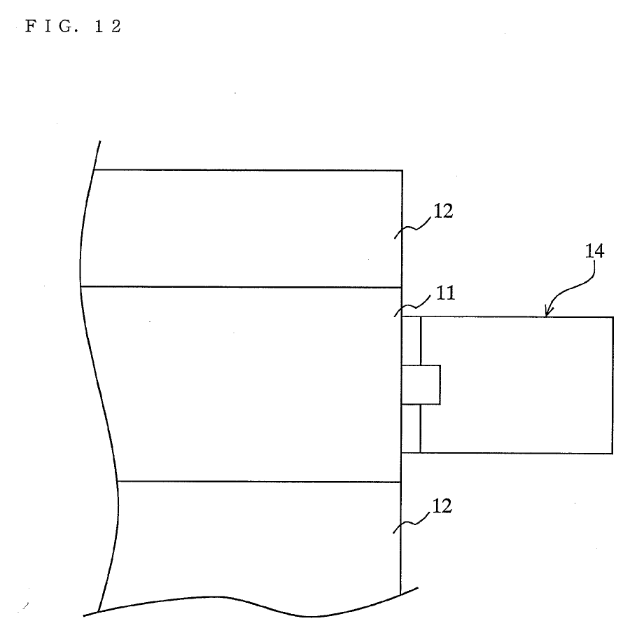

FIG. 13 shows a y-z cross section of an optical module 3 according to a third embodiment of the present invention. In the optical module 3 shown in FIG. 13, the light-receiving body 143 that has a semiconductor structure in the optical module 1 and the optical module 2, is substituted with: a transparent organic host material that has a conductive property; and an organic pigment 146 which absorbs a wavelength dispersed within the organic host material and which then generates a charge.

For the optical module 3, it is necessary to provide an electrode 147 for extracting the charge derived by the organic pigment 146. Furthermore, polysilane or the like is used as the organic host material, since, in addition to the transparency and the conductive property of organic host material, it is preferred if the same material as the core 11 is used.

According to the third embodiment, a parallel optical interconnection that does not allow any cross talk can be attained in a cover cladding structure, even when the optical module of the present invention includes the light-receiving section 14 that utilizes the organic pigment 146.

<Configurational Example of the Light-Receiving Section 14>

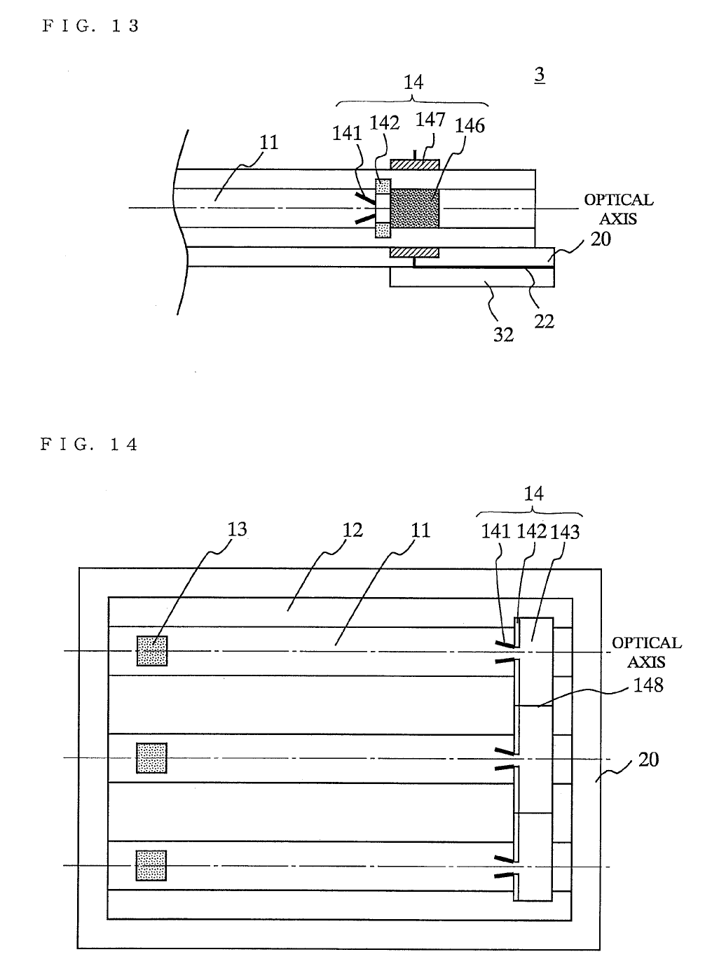

N number of the light-receiving sections 14 that respectively correspond to N number of the cores 11 are provided in the optical module that has the parallel optical interconnection. A structure of the N number of the light-receiving sections 14 may be, a structure as shown in FIG. 2C and FIG. 8C where each of the light-receiving sections 14 are independent from each other, or a structure as shown in FIG. 14 where the N number of the light-receiving sections 14 are integrated. In the latter case, a blocking layer 148 is provided in order to electrically separate each of the light-receiving bodies 143. Needless to say that the tapered reflective side surface 141 may be the angle selection mirror 145.

<Manufacturing Process of the Optical Module>

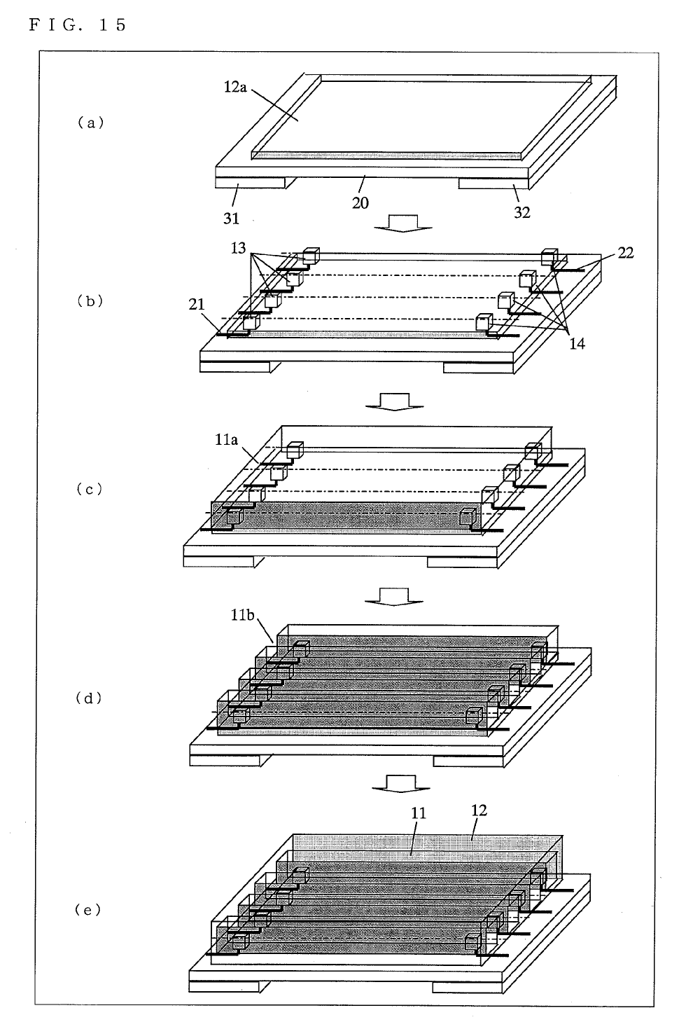

FIG. 15 is a figure for describing one example of a manufacturing process of the optical module described above.

First step: A cladding layer 12a, which is composed of a resin or a glass, is formed on the surface of the board 20 that is fixed on the fixation bases 31 and 32. (a) of FIG. 15. The cladding layer 12a is formed by means of spin coating, injection molding, a squeegee, and the like.

Second step: N number of pairs of the light source 13 and the light-receiving section 14 are parallelly arranged on the cladding layer 12a. Simultaneously, electrical signal wirings 21 and 22 are laid down. (b) of FIG. 15.

Third step: A resin core layer 11a is formed so as to integrally cover the surface of the cladding layer 12a, the light source 13, and the light-receiving section 14. (c) of FIG. 15. The core layer 11a is formed by means of spin coating, injection molding, a squeegee, and the like, or by a lamination of existing films.

Fourth step: A groove 11b is provided on the core layer 11a, and the N number of the cores 11 that are embedded with the light source 13 and the light-receiving section 14 are formed. Additionally, side surfaces of each of the cores 11 are mirrorized. (d) of FIG. 15.

Fifth step: The cladding 12 that covers the cores 11 is formed. (e) of FIG. 15.

Procedures in the first step and the second step described above may be altered as follows.

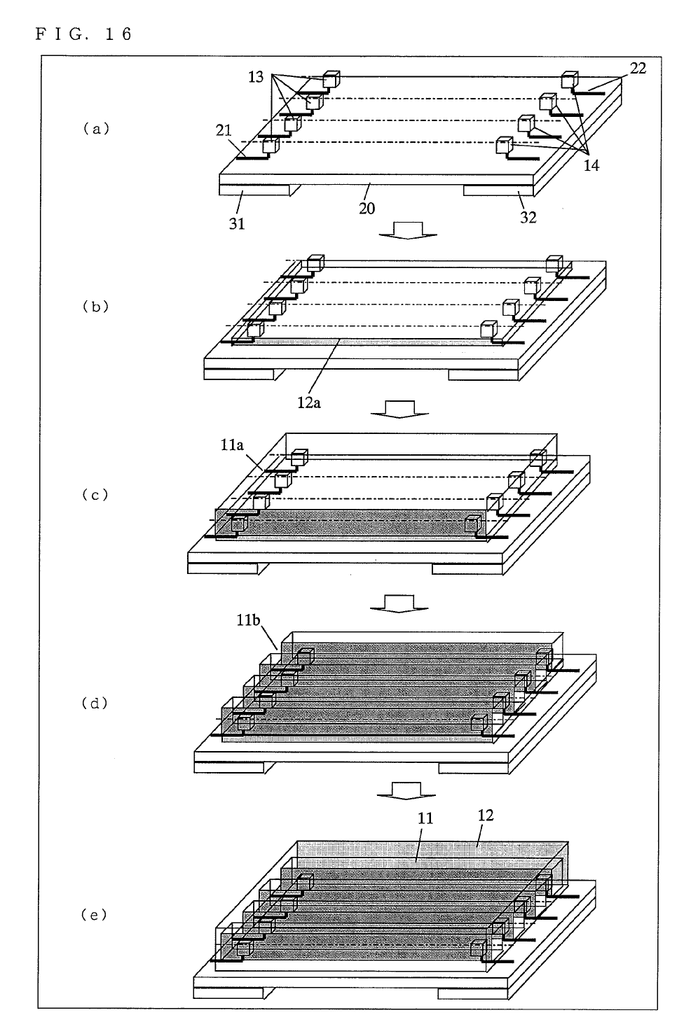

First step: N number of pairs of the light source 13 and the light-receiving section 14 are parallelly arranged on the surface of the board 20 that is fixed on the fixation bases 31 and 32. Simultaneously, electrical signal wirings 21 and 22 are laid down. (a) of FIG. 16.

Second step: A cladding layer 12a, which is composed of a resin or a glass and which has an refractive index that is lower than a light emitting section of the light source 13 and a incident light guiding section (the tapered reflective side surface 141 or the angle selection mirror 145) of the light-receiving section 14, is formed on the surface of the board 20. The cladding layer 12a is formed by means of spin coating, injection molding, a squeegee, and the like. (b) of FIG. 16.

The procedures in the third, forth, and fifth steps are identical to those described above. (c) to (e) of FIG. 16.

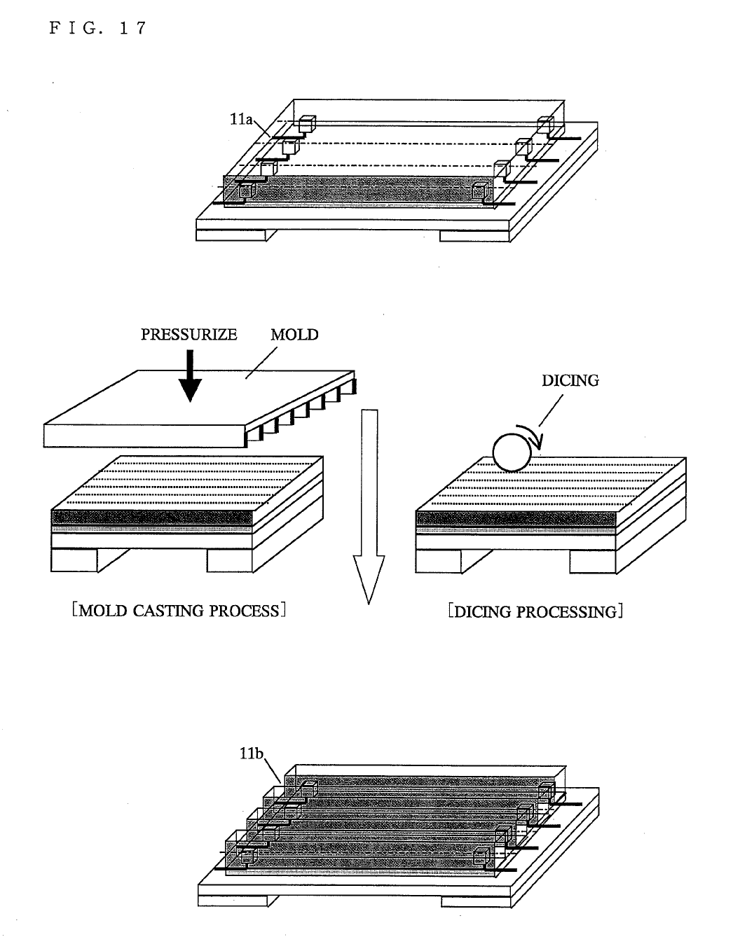

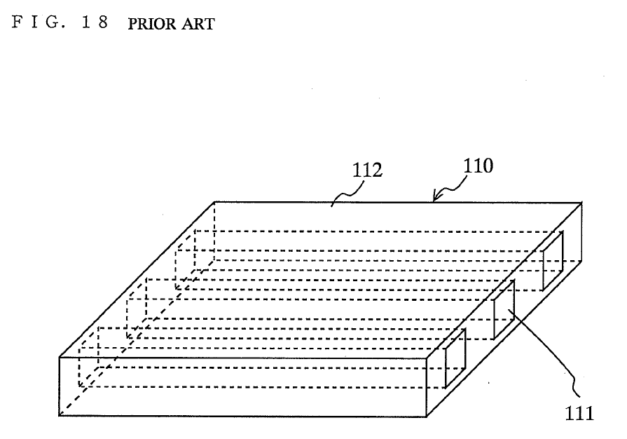

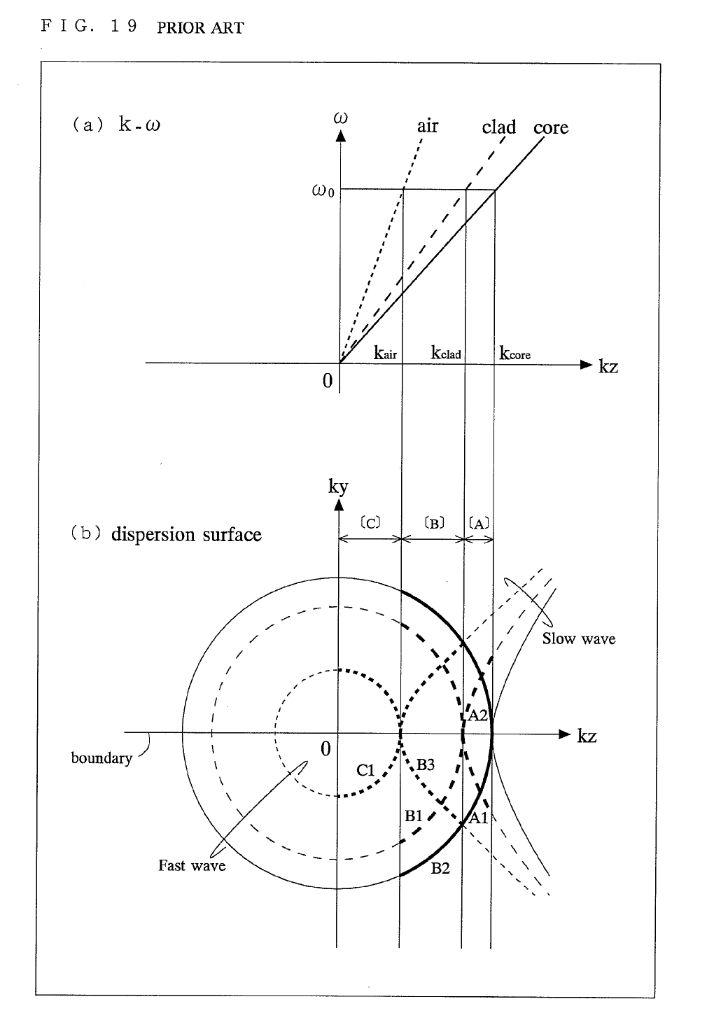

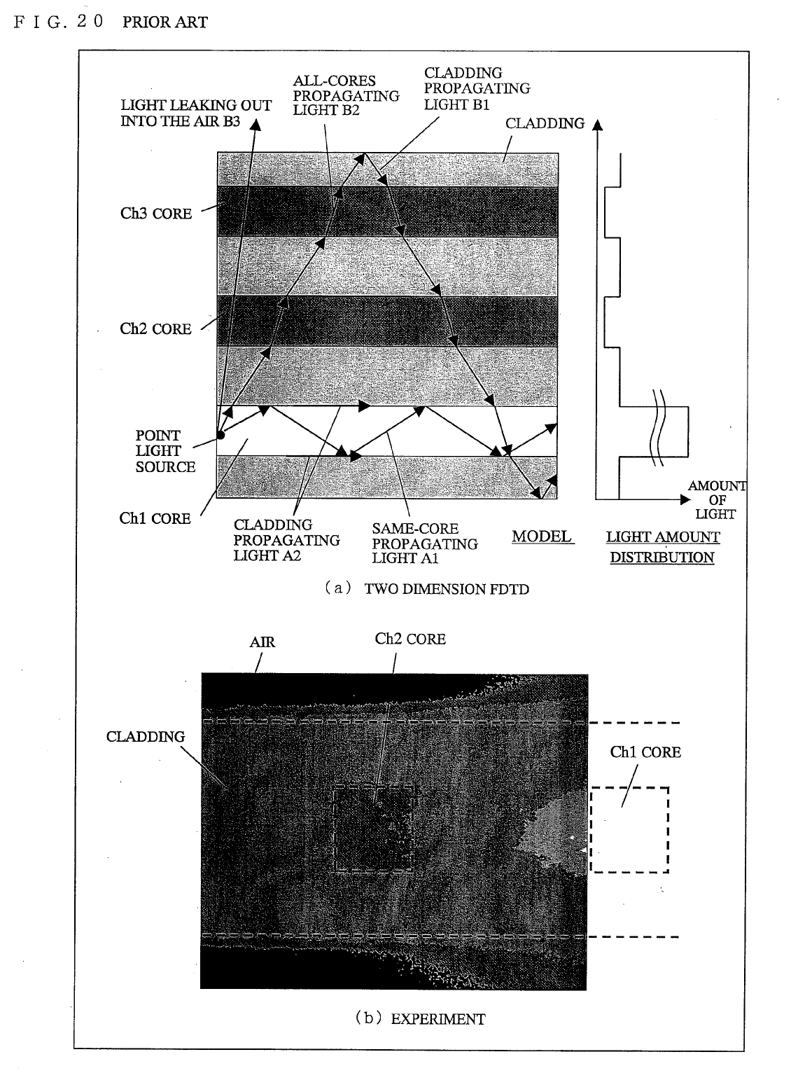

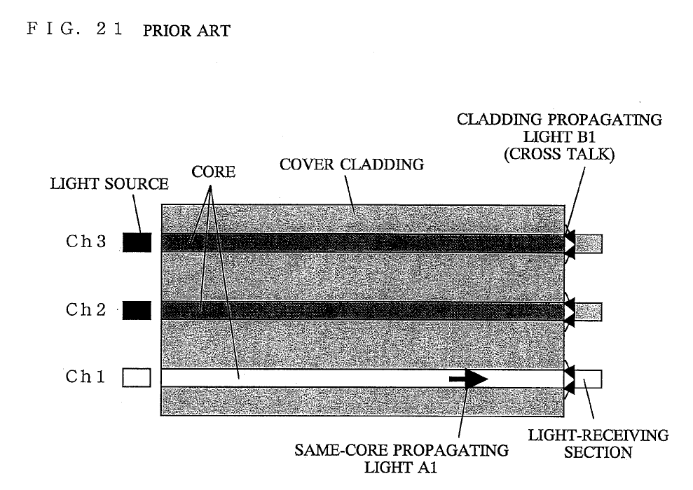

However, the processing method for the resin core layer 11a in the fourth step will be changed to some degree depending on the final configuration of the optical waveguide 10. When the light source 13 and the light-receiving section 14 are provided as being independent from each other for every channel in the final configuration, in addition to conducting dicing processing and mold casting process shown in FIG. 17, effective processing methods that can be applied are: physical processing such as, etching that utilizes a mask, preferential etching that uses an electron beam and an ion beam, and the like; and chemical processing in which a core portion (or a portion other than the core) is irradiated with an electromagnetic wave, such as ultraviolet ray and the like while a mask is being utilized, so as to increase (or decrease) a refractive index of an irradiated portion. When the light source 13 and the light-receiving section 14 are respectively provided as an array light emitting section and an array effective light-receiving section in the final configuration, the physical processing and the chemical processing are both effective.

When an array part, in which the N number of pairs of the light source 13 and the light-receiving section 14 are optically coupled individually by the N number of the cores 11, is prepared in advance; the only required steps are, the first step of disposing the array part on the surface of the board 20 and laying the electrical signal wirings 21 and 22, and the second step of forming the cladding 12 that covers the array part.

As described above, the optical modules 1 to 3 according to the present invention, which include the light-receiving section 14 that has the incident light guiding section (the tapered reflective side surface 141 or the angle selection mirror 145), can reduce the cross talk between the channels, therefore, there is an advantage of being able to omit a step of molding a groove and a wall between cores in the manufacturing process of the optical module.

While the invention has been described in detail, the foregoing description is in all aspects illustrative and not restrictive. It is understood that numerous other modifications and variations can be devised without departing from the scope of the invention.

What is claimed is:

1. An optical module that has a cover cladding structure, the optical module comprising:
a plurality of light sources;
a plurality of light-receiving sections; and
an optical waveguide that includes, a plurality of cores which individually align an optical axis of each of the plurality of light sources and an optical axis of each of the plurality of light-receiving sections and which conduct optical coupling of the light source and the light-receiving section, and a cladding that covers the plurality of cores, wherein
each of the plurality of light-receiving sections includes:
a light-receiving body that receives a light; and
an incident light guiding section that guides, among incident lights that propagate through the cores, only a light having an incidence angle within a range whose upper limit is an angle decided based on NA of the optical waveguide, to the light-receiving body.

2. The optical module according to claim 1, wherein
the incident light guiding section includes a tapered reflective side surface that has: a light-reflecting function; a spread angle whose center line matches the optical axis and which faces toward a direction from where an incident light arrives; and a shape where an aperture diameter at a tip of the tapered reflective side surface is equal to or less than a minimum width of the core.

3. The optical module according to claim 2, wherein
the spread angle and the aperture diameter of the incident light guiding section are derived based on a refractive index of the core in the optical waveguide and on a refractive index of the cladding in the optical waveguide.

4. The optical module according to claim 1, wherein
the incident light guiding section includes an angle selection mirror which is formed of a transparent material that has a refractive index equal to or smaller than a value of a square root of a difference between a square of the refractive index of the core in the optical waveguide and a square of the refractive index of the cladding in the optical waveguide, and which has a plane perpendicular to the optical axis facing toward a direction from where an incident light arrives, and which selects a light that passes through based on the incidence angle.

5. The optical module according to claim 2, wherein
at least a tip portion of the tapered reflective side surface is either embedded inside the core or in contact with an end surface of the core.

6. The optical module according to claim 4, wherein
the plane of the angle selection mirror perpendicular to the optical axis, is either embedded inside the core or in contact with an end surface of the core.

7. The optical module according to claim 1, wherein
the light-receiving body includes:
a photoelectric conversion section that converts a received light into a charge; and
an electrode pair that collects the charge generated by the photoelectric conversion section.

8. The optical module according to claim 7, wherein
the photoelectric conversion section is a P-N junction type semiconductor.

9. The optical module according to claim 7, wherein
the photoelectric conversion section includes a transparent organic host material that has a conductive property, and an organic pigment which absorbs a wavelength dispersed within the organic host material and which then generates a charge.

10. The optical module according to claim 9, wherein
the organic host material is a same material as the core.

11. The optical module according to claim 1, further comprising:
a board on which the optical waveguide is mounted and which is curvable toward a direction of a normal line to the optical axis; and
a fixation base that fixes the board.
